(19) United States
(12) Patent Application Publication
(10) Pub. No.: US 2022/0321751 A1
(43) Pub. Date: Oct. 6, 2022

(54) CAMERA VIEWFINDER SYSTEM

(71) Applicant: TILTA INC., Burbank, CA (US)

(72) Inventors: Wenping Zeng, Burbank, CA (US); Kefeng Zhou, Burbank, CA (US)

(21) Appl. No.: 17/223,997

(22) Filed: Apr. 6, 2021

(51) Int. Cl. H04N 5/225; H04N 5/232; G03B 13/02

(52) U.S. Cl. CPC H04N 5/225251; H04N 5/232935; G03B 13/02; G03B 2213/02

(57) ABSTRACT

An electronic viewfinder (EVF) can be operatively connected to a camera using a flexible EVF extension system that allows the use of the EVF at a large number of positions relative to the camera. The flexible connection system can be used in various configurations that can mitigate the difficulty of using the EVF in different shooting scenarios. The EVF enables a photographer to operate a camera in a large number of shooting scenes to achieve various shooting effects with ease.

### TECHNICAL FIELD

The present disclosure generally relates to a viewfinder apparatus for a camera, and in particular, a flexible viewfinder apparatus and a wearable viewfinder apparatus.

### INTRODUCTION

A digital camera typically provides a viewfinder for aiding photo or video composition during shooting. A viewfinder can be an optical viewfinder or an electronic viewfinder. An optical viewfinder can observe an image of a subject through an optical path. Examples of the electronic viewfinder include an LCD (liquid-crystal display) monitor and OLED (organic light-emitting diode) monitor. The electronic viewfinder (EVF) can also be used to display photos and/or videos that are stored in a digital camera. The electronic viewfinder can also provide a user interface for operating, configuring, and controlling various functions and operations of a camera.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Aspects of the present disclosure provide an electronic viewfinder apparatus, system, assembly, and method that can provide ease of operation and flexible camera configurations suitable for different applications and installation scenarios when using an electronic viewfinder (EVF).

One aspect of the disclosure provides a camera viewfinder apparatus. The camera viewfinder apparatus includes an electronic viewfinder (EVF) and a viewfinder support configured to removably connect with the EVF. The viewfinder support includes an EVF interface configured to communicatively and removably connect with the EVF to provide the EVF with an image signal from a camera. The viewfinder support further includes a camera interface configured to communicatively and removably connect with the camera to receive the image signal from the camera. The camera viewfinder apparatus further includes a signal transport configured to communicatively connect the viewfinder support with the camera to transfer the image signal from the camera to the viewfinder support.

According to one aspect of the camera viewfinder apparatus, the viewfinder support includes a viewfinder mount that includes a plurality of first mounting interfaces respectively located on different sides of the viewfinder support.

According to one aspect of the camera viewfinder apparatus, the plurality of first mounting interfaces include a plurality of male cold shoe interfaces configured to removably connect the viewfinder mount with a support member in a plurality of orientations.

According to one aspect of the camera viewfinder apparatus, the viewfinder support further includes a control handle comprising a button that is operable to control a recording operation (e.g., start/stop recording) of the camera.

According to one aspect of the camera viewfinder apparatus, the viewfinder support further includes an adjustable bracket. The adjustable bracket includes a rotatable mounting interface configured to removably connect with the viewfinder mount. The rotatable mounting interface is rotatable around a first axis. The adjustable bracket further includes a pivot portion that forms an opening for receiving an elongated member of a camera mounting bracket. The elongated member is rotatable around a second axis of the opening.

According to one aspect of the camera viewfinder apparatus, the adjustable bracket further includes a first locking mechanism for locking an angular position of the rotatable mounting interface around the first axis; and a second locking mechanism for locking an angular position of the adjustable bracket around the second axis.

According to one aspect of the camera viewfinder apparatus, the viewfinder mount includes a first signal interface and a second signal interface. The first signal interface is configured to receive the image signal in a first format from the camera, and the second signal interface is configured to transmit the image signal in a second format to the EVF.

According to one aspect of the camera viewfinder apparatus, the viewfinder mount further includes a signal conversion circuit configured to convert the image signal from the first format to the second format.

According to one aspect, the camera viewfinder apparatus further includes a camera adapter. The camera adapter includes a first signal interface configured to removably and mechanically connect with an external signal interface of the camera to receive the image signal from the camera. The camera adapter further includes a second signal interface configured to transmit the image signal to the viewfinder support.

According to one aspect of the camera viewfinder apparatus, the signal transport is configured to transfer the image signal using a connection cable or wireless communication.

One aspect of the disclosure provides a viewfinder mount for an electronic viewfinder (EVF). The viewfinder mount includes a first signal interface configured to receive a first image signal from a camera. The viewfinder mount further includes a second signal interface configured to removably connect with an electronic viewfinder (EVF) and transmit a second image signal corresponding to the first image signal to the EVF. The viewfinder mount further includes a plurality of mounting interfaces that are respectively located on different sides of the viewfinder mount.

According to one aspect of the viewfinder mount, the plurality of mounting interfaces include a plurality of cold shoe interfaces respectively facing different directions.

According to one aspect of the viewfinder mount, the plurality of cold shoe interfaces includes a first cold shoe interface, a second cold shoe interface, and a third cold shoe interface. The first cold shoe interface is located on a first side of the viewfinder mount. The second cold shoe interface is located on a second side of the viewfinder mount, and the second side is perpendicular to the first side. The third cold shoe interface is located on a third side of the viewfinder mount, and the third side is perpendicular to the second side and parallel to the first side.

According to one aspect of the viewfinder mount, the second signal interface is located on a fourth side of the viewfinder mount between the first side and the third side.

In one aspect, the viewfinder mount further includes a format conversion circuit configured to convert the first image signal to the second image signal.

One aspect of the disclosure provides a wearable camera viewfinder apparatus. The wearable camera viewfinder apparatus includes a wearable frame configured to be worn by a user and at least one electronic viewfinder (EVF) assembly. The at least one EVF assembly is rotatably connected with the wearable frame such that the at least one EVF assembly corresponds to the eye of the user. The at least one EVF assembly includes a camera interface configured to receive an image signal from a camera using at least one of a connection cable or a wireless connection between the EVF assembly and the camera.

According to one aspect of the wearable camera viewfinder apparatus, the wearable frame includes an eye frame, a right arm, and a left arm. The right arm is pivotably connected with a first end of the eye frame. The left arm is pivotably connected with a second end of the eye frame. The at least one EVF assembly is pivotably connected to the eye frame.

According to one aspect of the wearable camera viewfinder apparatus, at least one of the right arm or the left arm includes a first portion and a second portion. The first portion has a first end and a second end, and the first end is pivotably connected with the eye frame. The second portion is slidably connected with the second end of the first portion, and the second portion includes a bent portion shaped for engaging an ear of the user.

According to one aspect of the wearable camera viewfinder apparatus, the at least one EVF assembly includes an electronic viewfinder (EVF) that includes a signal interface and a viewfinder mount. The viewfinder mount includes an EVF interface configured to communicatively and removably connect with the signal interface of the EVF for transferring the image signal.

According to one aspect of the wearable camera viewfinder apparatus, the viewfinder mount further includes a camera interface for receiving the image signal from the camera via a connection cable removably connected between the camera interface and the camera.

According to one aspect of the wearable camera viewfinder apparatus, wherein the EVF includes an eyecup for covering an eye of the user.

According to one aspect of the wearable camera viewfinder apparatus, the at least one EVF assembly includes a first EVF assembly corresponding to the right eye of the user and a second EVF assembly corresponding to the left eye of the user. The first EVF assembly and the second EVF assembly are independently pivotable with respect to the eye frame.

According to one aspect of the wearable camera viewfinder apparatus, wherein the at least one EVF assembly includes at least one button operable to control an operating mode of the first EVF assembly and the second EVF assembly. The operating mode includes a binocular mode, monocular mode, and a multi-camera mode.

In one aspect, the wearable camera viewfinder further includes a camera adapter. The camera adapter includes a first signal interface and a second signal interface. The first signal interface is configured to removably connect to the camera to receive the image signal. The second signal interface is configured to transmit the image signal to the at least one EVF assembly.

These and other aspects of the invention will become more fully understood upon a review of the detailed description, which follows. Other aspects, features, and implementations will become apparent to those of ordinary skill in the art, upon reviewing the following description of specific, exemplary implementations in conjunction with the accompanying figures. While features may be discussed relative to certain implementations and figures below, all implementations can include one or more of the advantageous features discussed herein. In other words, while one or more implementations may be discussed as having certain advantageous features, one or more of such features may also be used in accordance with the various examples discussed herein. In similar fashion, while exemplary implementations may be discussed below as apparatus, device, system, or method implementations, it should be understood that such examples can be implemented in various devices, systems, and methods.

### BRIEF DESCRIPTION OF THE DRAWINGS

FIGS. 1 and 2 are drawings illustrating a camera, an electronic viewfinder (EVF), and components of an EVF extension system according to some aspects of the disclosure.

FIG. 3 is a drawing illustrating an EVF connected with a camera using a first configuration of the EVF extension system according to some aspects of the disclosure.

FIG. 4 is a drawing illustrating an EVF connected with a camera using a second configuration of the EVF extension system according to some aspects of the disclosure.

FIG. 5 illustrates block diagrams of an EVF and a control handle of the EVF extension system according to some aspects of the disclosure.

FIG. 6 illustrates a block diagram of a viewfinder mount according to some aspects.

FIGS. 7 and 8 are drawings illustrating a camera, an EVF, and components of an EVF extension system according to some aspects of the disclosure.

FIG. 9 is a drawing illustrating an EVF directly connected with a camera without using an EVF extension system according to some aspects of the disclosure.

FIGS. 10 and 11 are drawings illustrating a wearable electronic viewfinder device according to some aspects of the disclosure.

FIG. 12 is a drawing illustrating an exemplary electronic viewfinder according to some aspects of the disclosure.

FIG. 13 is a drawing illustrating a wearable frame for the electronic viewfinder of FIG. 12 according to some aspects of the disclosure.

FIG. 14 is a drawing illustrating a configuration of the wearable electronic viewfinder device of FIGS. 10 and 11 according to some aspects of the disclosure.

FIG. 15 is a drawing illustrating another configuration of the wearable electronic viewfinder device according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

In the field of photography, photographers can compose and obtain the desired shooting effect through an electronic viewfinder (EVF). A typical EVF is installed and rigidly fixed on the camera. Therefore, in some shooting scenarios, it can be inconvenient or impractical for the photographer to monitor or operate the EVF due to space and/or position limitations. Therefore, aspects of the present disclosure provide an EVF apparatus and system that can flexibly connect an EVF to a camera such that the EVF can be used in various shooting scenarios with ease.

In some aspects, an electronic viewfinder (EVF) extension system allows an EVF to be operatively connected with a camera to enable the use of the EVF at a large number of positions relative to the camera. In some aspects, the EVF extension system can be used in various configurations that can mitigate the difficulty of using the EVF in different shooting scenarios. The EVF extension system enables a photographer to operate a camera in a large number of shooting scenes to achieve various shooting effects with ease.

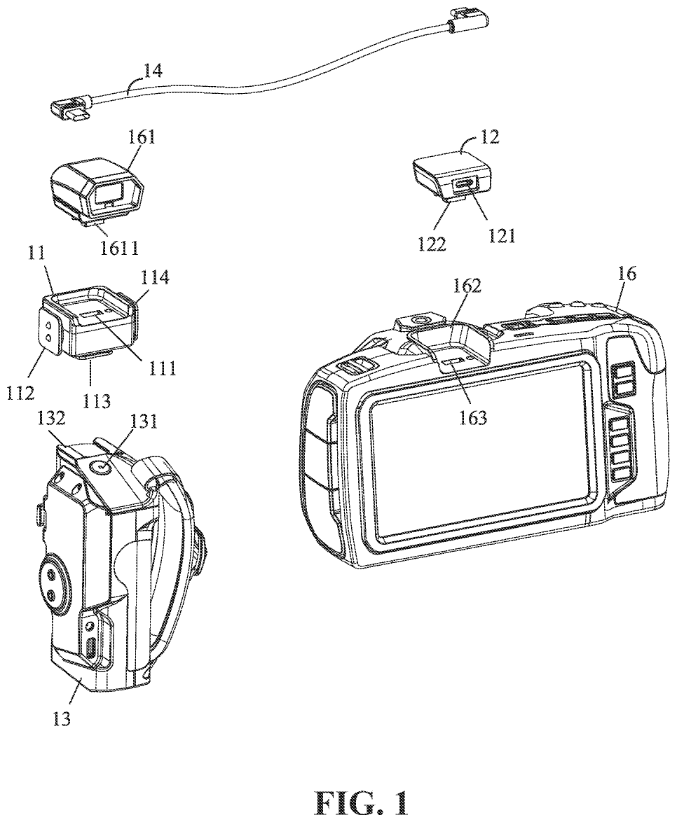

Referring now to FIGS. 1-9, an implementation of an electronic viewfinder system is described below in more detail. The electronic viewfinder system can include a viewfinder mount 11, a camera adapter 12, a connection cable 14, a control handle 13, and an adjustable bracket 15. In one aspect, the viewfinder mount 11 can have an EVF interface 111 (e.g., a signal interface) that can operatively and removably connect with an electronic viewfinder (e.g., EVF 161), one or more mounting interfaces (e.g., male cold shoe interfaces 112, 113, and 114) on different sides of the viewfinder mount 11, and an interface port 115. The interface port 115 (e.g., a signal interface) can have a number of electrical connectors that are used for signal communication with and receiving power from a camera 16. The camera 16 can capture images and video and convert that to an image signal (e.g., digital signal or data) for transmission.

In some aspects, the EVF 161 can have a camera interface 1611 that can be removably and electrically installed in the EVF interface 111 of the viewfinder mount 11. The camera interface 1611 can provide the EVF 161 with power, for example, supplied from the camera 16 via the viewfinder mount 11. Further, the camera interface 1611 can provide a communication interface between the EVF 161 and the viewfinder mount 11. The communication interface can be implemented using any suitable signal communication bus, channel, or interconnection, for example, USB (Universal Serial Bus), PCIe (Peripheral Component Interconnect Express), FireWire, etc. In some aspects, the EVF 161 can include an electronic display (e.g., LCD or OLED monitor) that can display an image or video to a viewer. When the EVF 161 is operatively connected with the camera 16 via the viewfinder mount 11 and camera adapter 12, the EVF 161 can display an image based on an image signal generated by the camera 16. For example, the camera 16 can generate the image signal based on images captured by its lens or stored at the camera 16, and the image signal can be transmitted to the EVF via the camera adapter 12 and/or viewfinder mount 11.

In some aspects, the camera 16 can have a viewfinder mount 162 that can receive the camera adapter 12 or the EVF 161. The viewfinder mount 162 can provide an external signal interface 163 that can communicatively and removably connect with the EVF 161 or the camera adapter 12. In some aspects, the camera adapter 12 has a signal interface 122 that can connect with the external signal interface 163 on the camera 16. For example, the signal interface 122 of the camera adapter 12 can electrically connect with the signal interface 163 of the camera 16 to allow power transfer and signal communication between the camera 16 and the camera adapter 12. The signal interface 163 of the camera allows the camera 16 to provide power to the EVF 161 and perform signal communication with the EVF 161, directly or via the camera adapter 12. The signal interface 122 of the camera adapter 12 can be removably installed in the signal interface 163 of the camera 16.

In some aspects, the camera adapter 12 and the viewfinder mount 11 can be operatively connected together using a signal transport (e.g., a signal cable or connection cable 14) that allows signal communication (e.g., image signal) and power transfer between the camera adapter 12 and the viewfinder mount 11. In one aspect, a first end 141 of the signal transport 14 can be connected with an interface port 115 of the viewfinder mount 11, and a second end 142 of the signal transport 14 can be connected with an EVF interface 121 of the camera adapter 12, so as to enable signal transmission and power transfer. In operation, the EVF 161 can receive power and an image signal from the camera 16 via the connection through the camera adapter 12, signal transport 14, and viewfinder mount 11. In some aspects, the EVF 161 may be powered using a power source (e.g., battery) that is independent of the camera 16. In that case, the signal transport 14 may not supply power to the EVF 161 via the EVF mount 11. In some aspects, the signal transport 14 can be replaced by a wireless connection that allows the camera 16 to send an image signal to the EVF 161 using wireless communication (e.g., Bluetooth, Wi-Fi, ultra-wideband, etc.).

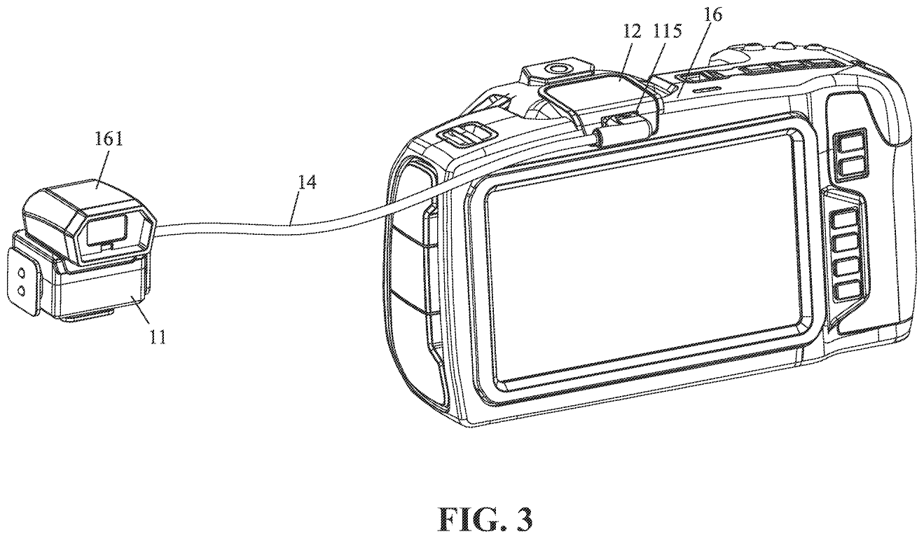

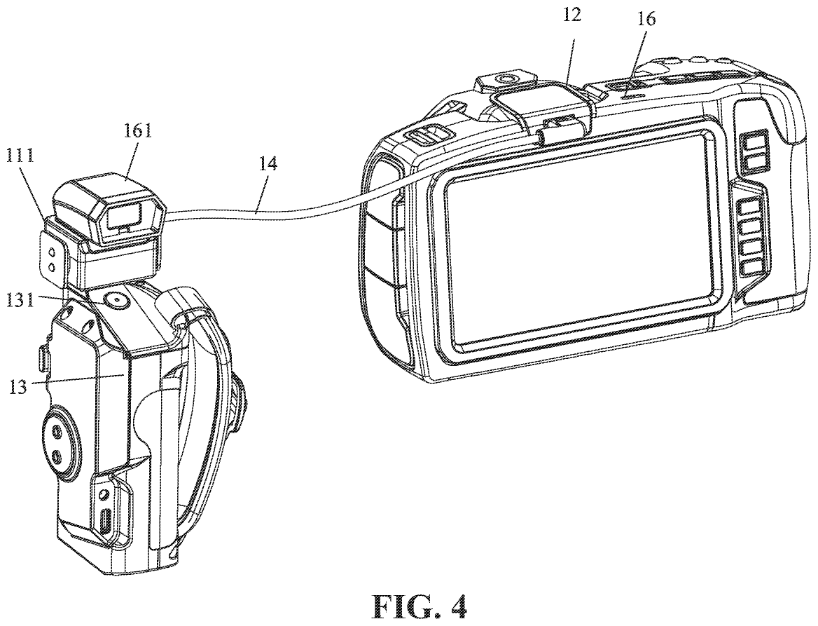

In some aspects, the viewfinder mount 11 can be removably connected with a control handle 13 by installing one of the male cold shoe interfaces 112, 113, or 114 in a suitable mounting interface (e.g., a female cold shoe interface 132) of the control handle 13. The control handle 13 can function as a handheld unit to provide a method for holding, maneuvering, and/or positioning the EVF 161 in the desired direction and/or position to facilitate shooting and composition of videos and photos. In some aspects, the control handle 13 can be equipped with one or more buttons or switches (e.g., button 131) that can be operated by a user for controlling one or more camera functions (e.g., start/stop of recording). For example, the button 131 can be operated to transmit a control signal to the camera 16 via a wireless signal (e.g., Bluetooth or Wi-Fi), and the camera 16 is equipped to receive the wireless signal and perform the corresponding functions. Therefore, a photographer can use the control handle 13 and the EVF 161 to monitor the shooting scene and remotely control the camera 16. FIG. 3 is a drawing illustrating the EVF 161 connected with the camera 16 using the viewfinder mount 11, camera adapter 12, and data transport 14 according to some aspects of the disclosure. FIG. 4 additional illustrates the control handle 13 connected to the viewfinder mount 11.

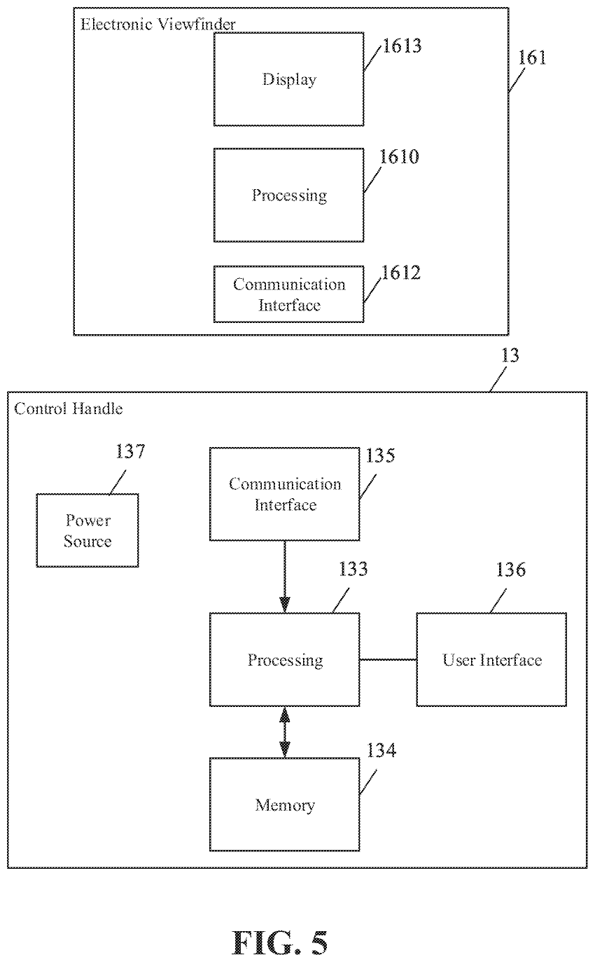

FIG. 5 illustrates block diagrams of the EVF 161 and the control handle 13 according to some aspects of the disclosure. Some components of the EVF 161 and control handle 13 that may be well known and not necessary for describing these devices may not be shown. In one aspect, the control handle 13 may include a processing circuit 133, a memory 134, a communication interface 135, and a user interface 136 (e.g., buttons 131). The control handle 13 may have a power source 137 (e.g., battery) that can supply power to operate the control handle 13. In some aspects, the power source 137 may receive power from an external power source (e.g., external battery pack). In some aspects, the processing circuit 133 can monitor the state of the button 131 via the user interface 136. In some aspects, the processing circuit 133 may include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functions of the control handle 13 described herein. The processing circuit 133 may execute software stored in the memory 134 to perform the functions of the control handle 13 described herein. The communication interface 135 may be configured to perform wireless and/or wired communication with a camera (e.g., camera 16). For example, the processing circuit 133 can send control commands to the camera 16 based on the input received from the button 131 to start/stop recording.

In one aspect, the EVF 161 may include a processing circuit 1610, a communication interface 1612, and a display 1613. In some aspects, the processing circuit 1610 may include microprocessors, microcontrollers, digital signal processors (DSPs), field programmable gate arrays (FPGAs), programmable logic devices (PLDs), state machines, gated logic, discrete hardware circuits, and other suitable hardware and/or software configured to perform various functions of the EVF 161 described here, for example, to display an image or video on the display 1613 based on an image signal received by the communication interface. In some aspects, the display 1613 may be an LCD monitor, OLED monitor, or the like. In some aspects, the communication interface 1612 can perform signal communication with the camera 16, for example, via the camera interface 1611 of the EVF 161 and the connection cable 14. In some aspects, the communication interface 1612 can be equipped to receive an image signal from a camera (e.g., camera 16) using wireless communication (e.g., Wi-Fi, Ultra-wideband, etc.). For example, the communication interface 1612 may include a wireless transceiver for wireless communication with the camera.

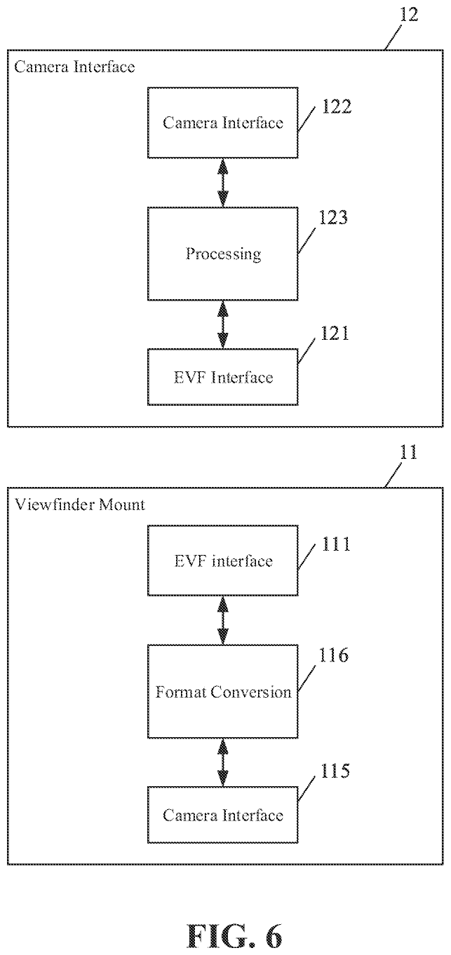

FIG. 6 is a block diagram illustration of the viewfinder mount 11 and camera adapter 12 according to some aspects. The viewfinder mount 11 has a first signal interface (e.g., EVF interface 111), a second signal interface (e.g., camera interface 115), and a format conversion circuitry 116. The format conversion circuitry 116 can receive an image signal of a first format from the camera 16 via the camera interface 115. For example, the camera interface 115 can receive the image signal from the camera 16 via the connection cable 14 and the camera adapter 12. The format conversion circuitry 116 can include a signal or format conversion circuit that can convert the image signal from a first format to a second format that can be displayed by the EVF 161. In some aspects, the format conversion circuitry 116 may not convert the image signal format when the EVF 161 can support the image signal of the first format. In that case, the format conversion circuitry 116 can simply transmit the image signal received from the camera interface 115 to the EVF 161 via the EVF interface 111 without using the format conversion circuitry 116. In some aspects, the viewfinder mount 11 may not include the format conversion circuitry 116. In some aspects, the format conversion circuitry 116 may include microprocessors, microcontrollers, digital signal processors (DSPs), field programmable gate arrays (FPGAs), programmable logic devices (PLDs), state machines, gated logic, discrete hardware circuits, and other suitable hardware and/or software configured to perform the various functions of the viewfinder mount 11 described herein.

The camera adapter 12 has an EVF interface 121, a camera signal interface 122, and processing circuitry 123. The processing circuitry 123 can receive an image signal of a first format from the camera 16 via the camera signal interface 122. For example, the camera signal interface 122 can receive the image signal via the external signal interface 163 of the camera 16. The processing circuitry 123 can convert the image signal from a first format to a second format that can be supported by an EVF (e.g., EVF 161). In some aspects, the processing circuitry 123 may not convert the image signal format when the EVF can support the image signal of the first format. In that case, the processing circuitry 123 can simply transmit the image signal of the first format to the EVF via the EVF interface 121. In some aspects, the camera adapter 12 can transfer power and an image signal from the camera signal interface 122 to the EVF interface 121 without format conversion. In some aspects, the camera adapter 12 may not include the processing circuitry 123. In some aspects, the processing circuitry 123 may include microprocessors, microcontrollers, digital signal processors (DSPs), field programmable gate arrays (FPGAs), programmable logic devices (PLDs), state machines, gated logic, discrete hardware circuits, and other suitable hardware and/or software configured to perform the various functions of the camera adapter 12 described herein. In some aspects, the EVF interface 121 may be equipped to communicate with the EVF 161 using wireless communication (e.g., Wi-Fi, Bluetooth, Ultra-wideband, etc.). For example, the EVF interface 121 may include a wireless transceiver for wireless communication with the EVF.

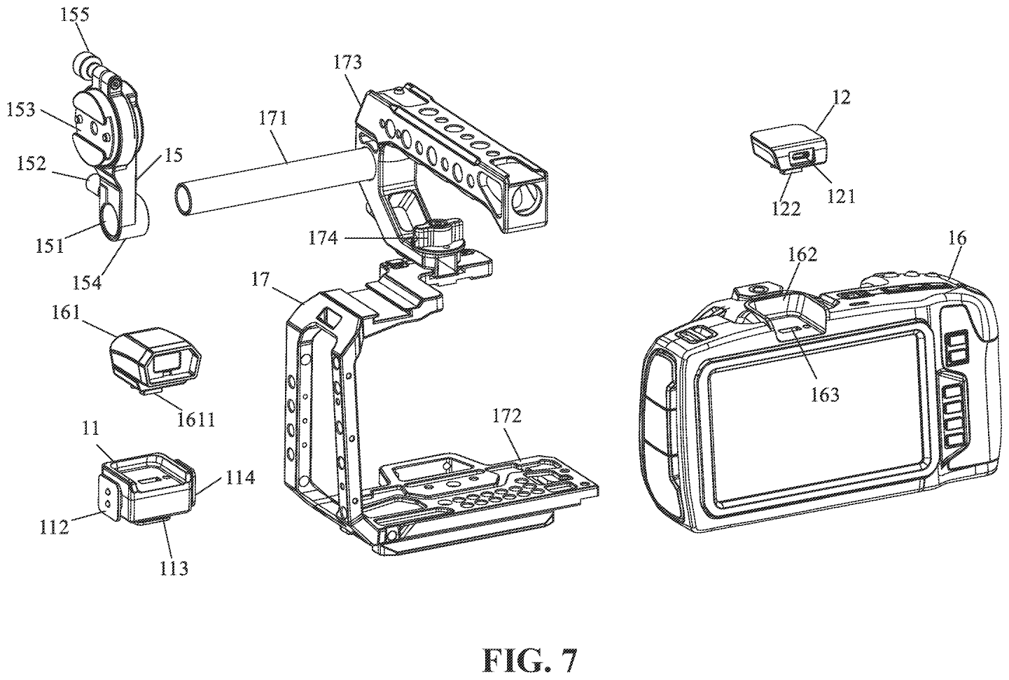

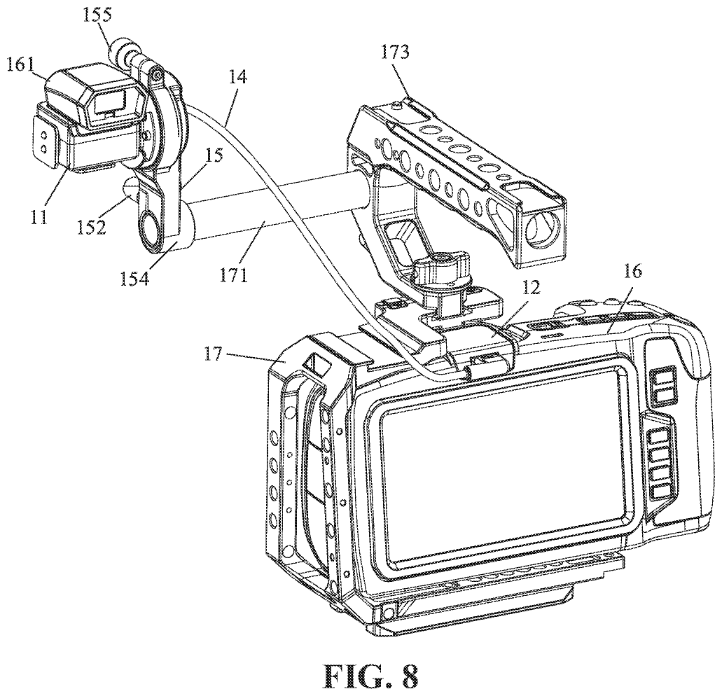

In some aspects, the above-described flexible EVF system includes a camera mounting bracket 17 (see FIGS. 7 and 8) that can be used with the camera 16. For example, the camera 16 can be removably installed on a camera mounting plate 172 at a lower portion of the camera mounting bracket 17. The upper portion (e.g., a handle portion 173) of the camera mounting bracket 17 may have an elongated member 171 (e.g., pipe, rod, or tube) for attaching additional equipment or accessories. For example, the elongated member 171 can extend along a width direction of the camera when it is installed on the camera mounting bracket 17.

In some aspects, the adjustable bracket 15 can be attached to the elongated member 171 through an opening 151 at a pivot portion 154 of the bracket. The opening 151 can be shaped to allow the elongated member 171 to slide easily therein. In one example, the opening 151 may have a cylindrical shape sized for limiting the movement of the elongated member 171 in a predetermined direction. For example, the elongated member 171 can move in a translational direction and rotate inside the opening 151 to enable flexible adjustment of the position and angle of the adjustable bracket 15 relative to the elongated member 171 and the adjustable bracket 15. The adjustable bracket 15 can also provide a first locking mechanism 152 (e.g., thumbscrew or latch) that can be operated to clamp on the elongated member 171 such that the angular position of the adjustable bracket 15 can be fixed at the desirable position with respect to the elongated member 171.

In some aspects, the adjustable bracket 15 can have a rotatable mounting interface (e.g., a female cold shoe interface 153) for removably connecting with the viewfinder mount 11. For example, the female cold shoe interface 153 can receive any one of the male cold shoe interfaces 112, 113, and 114 of the viewfinder mount 11. Therefore, the viewfinder mount 11 can be removably attached to the adjustable bracket 15 using the female cold shoe interface 153 in different orientations (e.g., horizontal and vertical orientations). In some aspects, the female cold shoe interface 153 can be adjustable in a rotational direction to adjust the rotational angle (angular position) of the female cold shoe interface 153 and the attached viewfinder mount 11. In one example, the rotational axis of the female cold shoe interface 153 can be parallel to an axial of the opening 151. The adjustable bracket 15 can provide a second locking mechanism 155 (e.g., a thumb screw or hand screw) for fixing a rotational angle (angular position) of the female cold shoe interface 153. When the second locking mechanism 155 is set in a released position, the female cold shoe interface 153 can freely rotate in the adjustable bracket 15. When the second locking mechanism 155 is set in a locked position, the female cold shoe interface 153 is fixed in the adjustable bracket 15. When an EVF assembly (e.g., the EVF 161 connected with the viewfinder mount 11) is attached to the adjustable bracket 15, the EVF assembly can be easily adjusted to the desired position. With the rotatable female cold shoe interface 153 and the opening 151, the adjustable bracket 15 can provide adjustment in two axes of rotation. For example, the female cold shoe interface 153 can be adjusted in a first rotational axis, and the opening 151 when attached to the elongated member 171 allows the adjustable bracket 15 to be adjusted (e.g., pivot or rotate) in a second rotational axis.

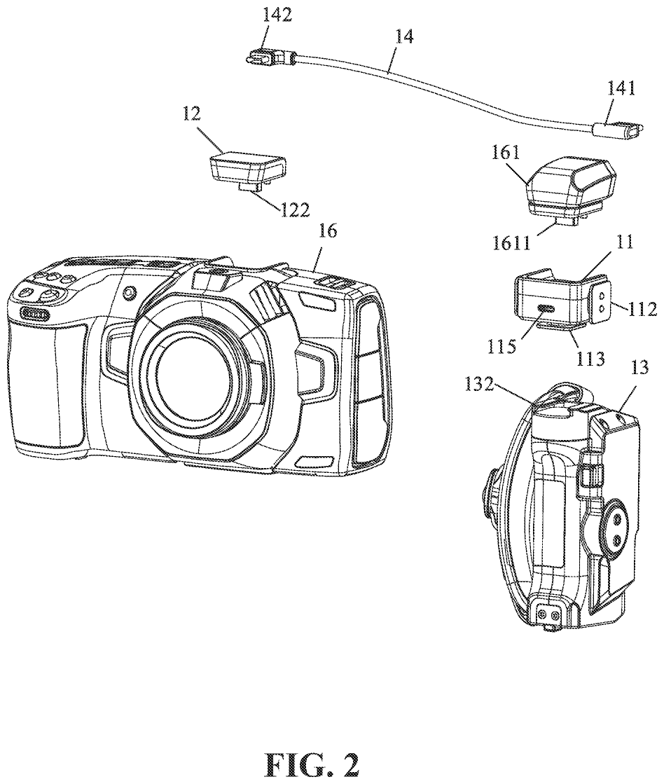

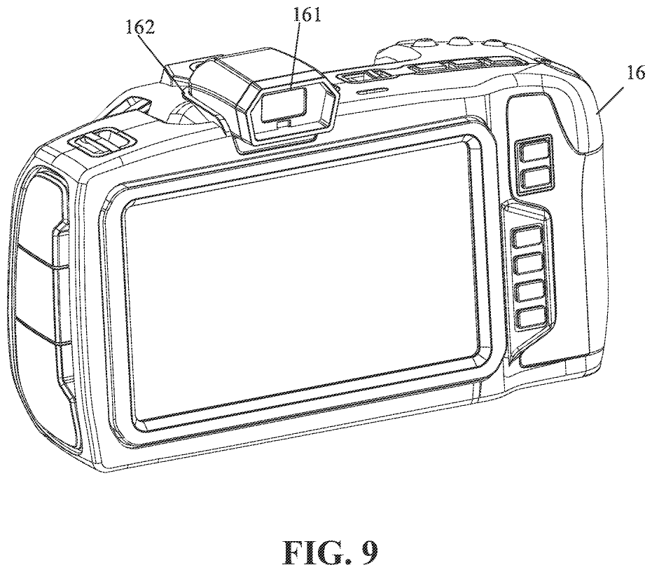

In some aspects, referring to FIG. 9, the EVF 161 can be directly and removably connected to the viewfinder mount 162 on the camera 16 without using the viewfinder mount 11 described above in relation to FIGS. 1-8. To this end, the camera interface 1611 (see FIGS. 1 and 2) of the EVF 161 can directly connect with the external signal interface 163 of the camera 16.

In some aspects, a viewfinder support can be an assembly including one or more of the viewfinder mount 11, the control handle 13, and the adjustable bracket 15.

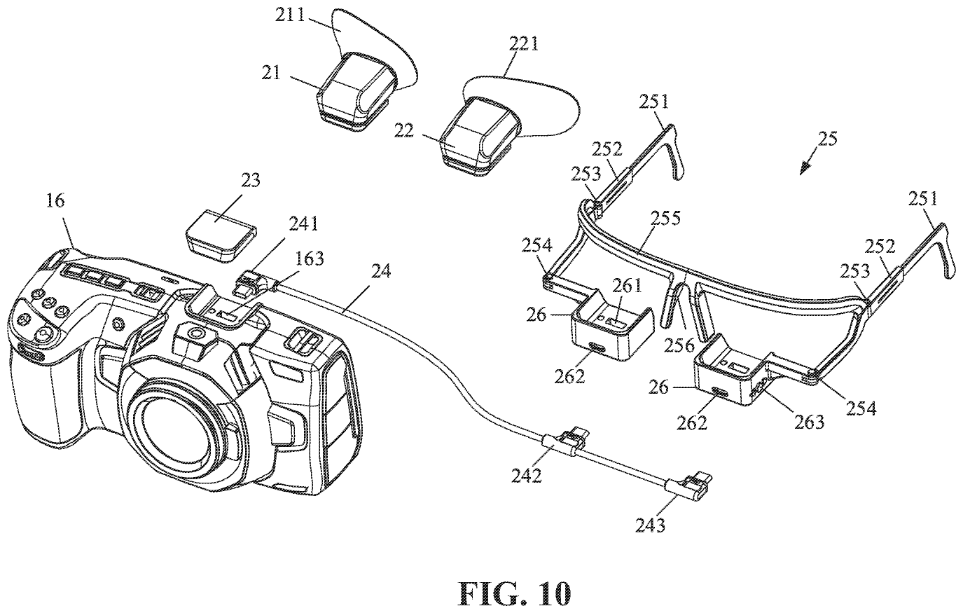

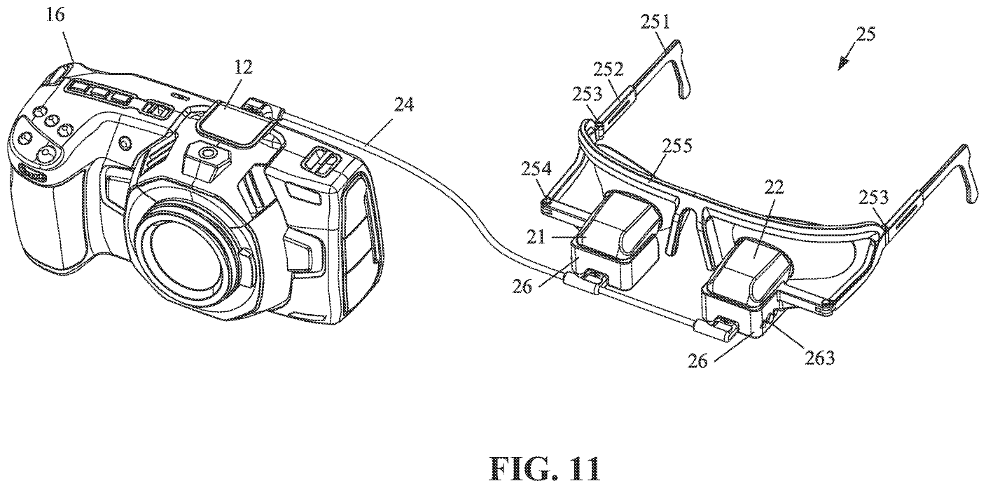

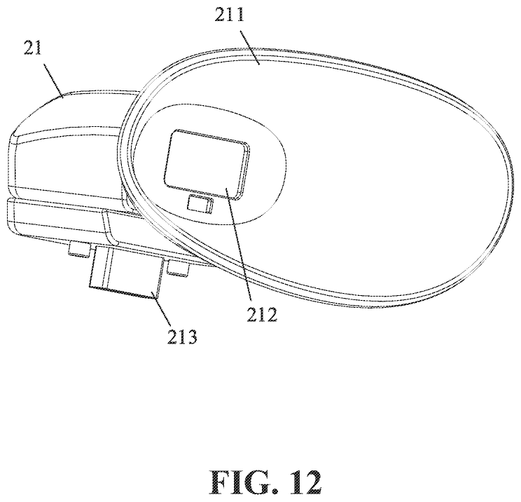

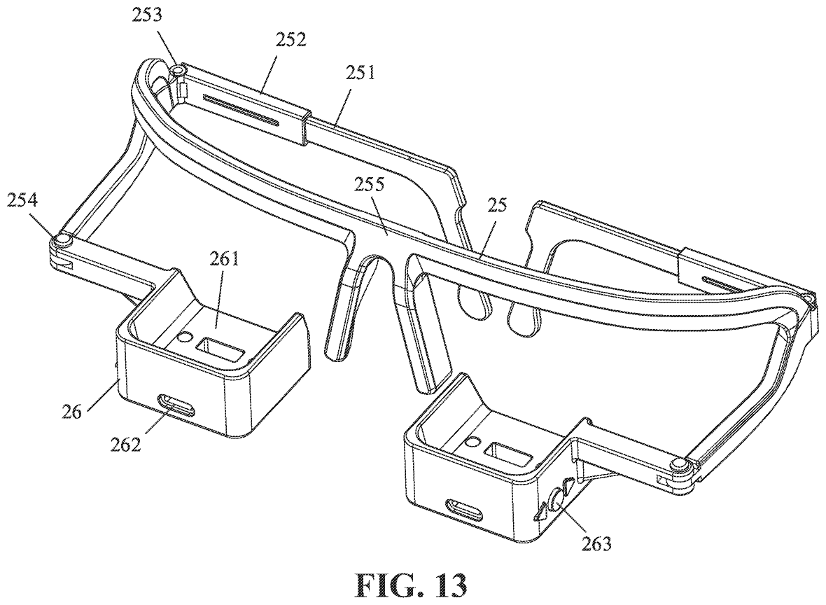

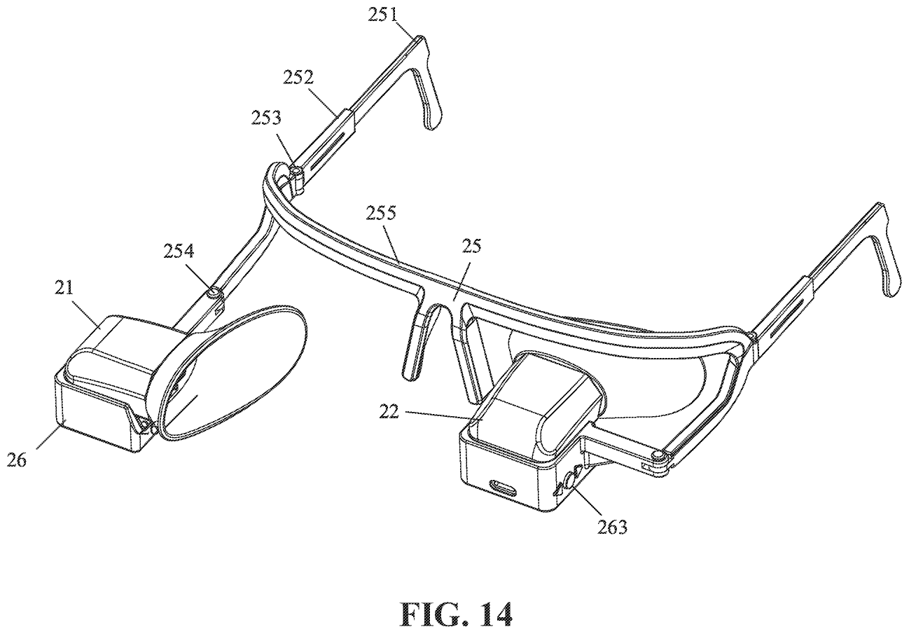

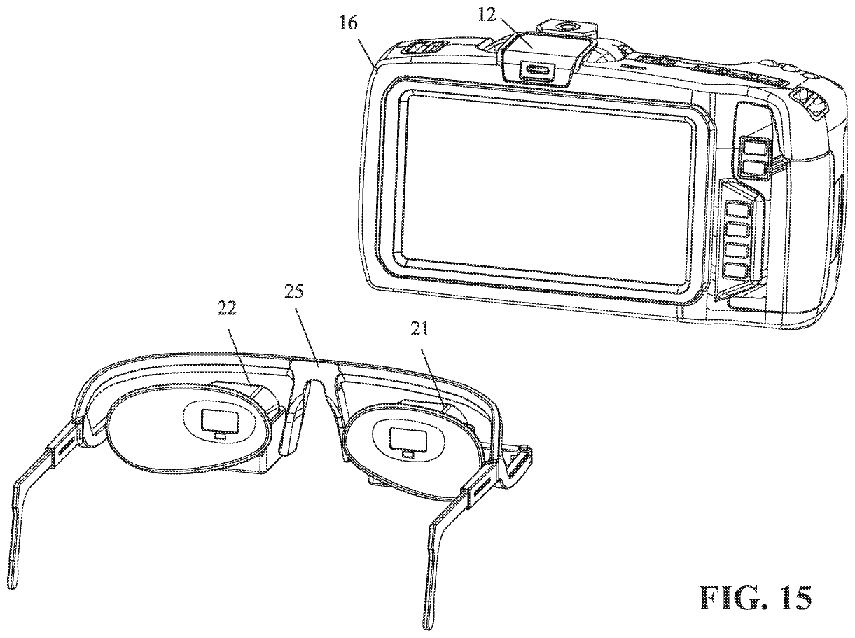

FIGS. 10-15 are drawings illustrating an implementation of a wearable electronic viewfinder apparatus according to some aspects of the disclosure. Referring to the drawings, the wearable electronic viewfinder device includes a right-eye EVF 21, a left-eye EVF 22, right and left viewfinder mounts 26, a camera adapter 23, a connection cable 24, and a wearable EVF apparatus 25. In some aspects, the right-eye EVF 21 and the left-eye EVF 22 can have the same in design and can be used interchangeably. Referring to FIG. 12, the right EVF 21 includes a right eyecup 211, a signal interface 213, and an image display 212. Similarly, the left-eye EVF 22 includes a left eyecup, a signal interface, and an image display. In some aspects, the eyecups 211 and 221 can be made of a matte black flexible material (e.g., silicone, rubber) that can cover the eyes or eye sockets of the user. The eyecups can protect the user's eyes and prevent stray light or glare from affecting the display 212 that can cause flare on the EVF and affect the image quality. The signal interface 213 can electrically and mechanically connect the EVF 21/22 to an EVF interface 261 on the corresponding viewfinder mount 26. The signal interface 213 can include a plurality of electrical connectors that allow signal communication and power transfer between the EVF and the viewfinder mount 26. The signal interface 213 allows the EVF 21/22 to be removably connected to the viewfinder mount 26.

In some aspects, the viewfinder mount 26 includes a camera interface 262 and an EVF interface 261. The camera interface 262 (e.g., a signal port) can receive electrical signals (e.g., an image signal) from the camera 16. The viewfinder mount 26 may include circuitry configured to process and transmit the image signal to the EVF 21/22 via the EVF interface 261. In some aspects, the viewfinder mount 26 may include circuitry configured to wirelessly receive the image signal from the camera 16.

In some aspects, the viewfinder mount 26 may be equipped with one or more control buttons (e.g., three exemplary buttons 263 shown in FIG. 10) for controlling or adjusting the different viewing modes of the EVFs, for example, a binocular mode, a monocular mode, and a multi-camera mode. The binocular mode uses both EVFs 21 and 22 to display an image and/or a setting interface of the camera 16. The monocular mode uses only the left-eye EVF 22 or right-eye EVF 21 to display an image and/or or a setting interface of the camera 16, such that the user can monitor the surrounding in real time without being obstructed by the unused EVF. To that end, one end of the viewfinder mount 26 is pivotably connected to one side of the EVF apparatus 25, for example, via a shaft 254 such that the viewfinder mount 26 can be rotated around the shaft 254. In other aspects, other designs for rotating the viewfinder mount 26 are also contemplated. The multi-camera mode can be used with multiple cameras that are used for shooting a scene at the same time. In this mode, the EVFs 21/22 can receive and process the imaging signals of multiple cameras and present the corresponding image on the EVFs. For example, the user can operate the buttons 263 to choose the image signals of a certain camera among the multiple cameras to be displayed on the EVFs. In some aspects, the EVFs can receive the image signals from a camera adapter that receives the image signals from multiple cameras.

In some aspects, the camera adapter 23 may be the same as the camera adapter 12 described above in relation to FIGS. 1-9. The camera adapter 23 may include an EVF interface 121 and a signal interface 122 (see FIG. 7). The EVF interface 121 provides an electrical interface for removably connecting the camera adapter 23 to a remotely located electronic viewfinder (e.g., EVFs 21 and 22) via a connection cable 24 or wirelessly. The signal interface 122 provides a structural and mechanical interface for removably connecting the camera adapter 23 to a camera 16. The signal interface 122 receives power and/or image signal from the camera 16. For example, the camera 16 can transmits power and image signal to the camera adapter 23 via the camera signal interface.

In some aspects, the camera adapter 23 can include circuitry similar to those included in the camera adapter 12, for example, signal processing circuitry (e.g., processing circuitry 123) and wireless communication circuitry (e.g., EVF interface 121). The signal interface 122 can removably connect to the EVF interface 163 of the camera 16 and exchange electronic signals (e.g., image signals) with the camera 16. Using the camera adapter 23, the camera 16 can transmit image signals to the viewfinder mounts 26 via wired transmission or wireless transmission. For example, a wired transmission can use a connection cable or data transport 24 between the camera adapter 23 and the viewfinder mounts 26. In one aspect, the connection cable 24 has a first connector 241 for removably connecting to the camera adapter 23, and two second connectors 242 and 243 for removably connecting to the two viewfinder mounts 26, respectively.

In some aspects, as shown in FIGS. 10, 11, 13-15, the EVF apparatus 25 includes an eye frame 255, left and right shafts 254 for rotatably connecting the eye frame 255 with the left and right viewfinder mounts 26. The EVF apparatus 25 further includes left and right folding shafts 253 for rotatably connecting the eye frame 255 with the left and right arms 252. The middle part 256 of the eye frame 255 can be provided with soft or flexible material for supporting the eye frame 255 on the nose bridge of a wearer. Each of the left and right arms 252 can have an extension portion 251. One end of the extension portion 251 has a bent portion (e.g., hook portion) shaped for engaging the ear of a wearer to secure the EVF apparatus 25, and the other end of the extension portion 251 is slidably and adjustably connected with the left/right arm 252.

In some aspects, the left and right arms 252 can respectively rotate or pivot around the corresponding folding shaft 253 onto the eye frame 255 in a folded configuration for easy storage when the wearable EVF apparatus 25 is not used. In some aspects, each extension portion 251 can telescope and slide inside a slot of the arm 252 to adjust the EVF apparatus 25 for the head size and/or ear position of the wearer. Each viewfinder mount 26 can independently rotate or pivot around the shaft 254 to adjust the positions of the EVF for the respective usage modes of the EVF apparatus 25.

While the above description contains many specific implementations of the invention, these should not be construed as limitations on the scope of the invention, but rather as examples of specific implementations thereof. Accordingly, the scope of the invention should be determined not by the implementations illustrated, but by the appended claims and their equivalents.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A camera viewfinder apparatus comprising:
an electronic viewfinder (EVF);
a viewfinder support configured to removably connect with the EVF, comprising:
an EVF interface configured to communicatively and removably connect with the EVF to provide the EVF with an image signal from a camera; and
a camera interface configured to communicatively and removably connect with the camera to receive the image signal from the camera; and
a signal transport configured to communicatively connect the viewfinder support with the camera to transfer the image signal from the camera to the viewfinder support.

2. The camera viewfinder apparatus of claim 1, wherein the viewfinder support comprises:
a viewfinder mount comprising a plurality of first mounting interfaces respectively located on different sides of the viewfinder support.

3. The camera viewfinder apparatus of claim 2, wherein the plurality of first mounting interfaces comprise a plurality of male cold shoe interfaces configured to removably connect the viewfinder mount with a support member in a plurality of orientations.

4. The camera viewfinder apparatus of claim 2, wherein the viewfinder support further comprises:
a control handle comprising a button operable to control a recording operation of the camera.

5. The camera viewfinder apparatus of claim 2, wherein the viewfinder support further comprises an adjustable bracket comprising:
a rotatable mounting interface configured to removably connect with the viewfinder mount, wherein the rotatable mounting interface is rotatable around a first axis; and
a pivot portion forming an opening for receiving an elongated member of a camera mounting bracket, wherein the elongated member is rotatable around a second axis of the opening.

6. The camera viewfinder apparatus of claim 5, wherein the adjustable bracket further comprises:
a first locking mechanism for locking an angular position of the rotatable mounting interface around the first axis; and
a second locking mechanism for locking an angular position of the adjustable bracket around the second axis.

7. The camera viewfinder apparatus of claim 2, wherein the viewfinder mount comprises:
a first signal interface configured to receive the image signal in a first format from the camera; and
a second signal interface configured to transmit the image signal in a second format to the EVF.

8. The camera viewfinder apparatus of claim 7, wherein the viewfinder mount further comprises:
a signal conversion circuit configured to convert the image signal from the first format to the second format.

9. The camera viewfinder apparatus of claim 1, further comprising a camera adapter comprising:
a first signal interface configured to removably and mechanically connect with an external signal interface of the camera to receive the image signal from the camera; and
a second signal interface configured to transmit the image signal to the viewfinder support.

10. The camera viewfinder apparatus of claim 1, wherein the signal transport is configured to transfer the image signal using a connection cable or wireless communication.

11. A viewfinder mount for an electronic viewfinder (EVF), comprising:
a first signal interface configured to receive a first image signal from a camera;
a second signal interface configured to removably connect with an electronic viewfinder (EVF) and transmit a second image signal corresponding to the first image signal to the EVF; and
a plurality of mounting interfaces respectively located on different sides of the viewfinder mount.

12. The viewfinder mount of claim 11, wherein the plurality of mounting interfaces comprise a plurality of cold shoe interfaces respectively facing different directions.

13. The viewfinder mount of claim 12, wherein the plurality of cold shoe interfaces comprise:
a first cold shoe interface located on a first side of the viewfinder mount;
a second cold shoe interface located on a second side of the viewfinder mount, the second side being perpendicular to the first side; and
a third cold shoe interface located on a third side of the viewfinder mount, the third side being perpendicular to the second side and parallel to the first side.

14. The viewfinder mount of claim 13, wherein the second signal interface is located on a fourth side of the viewfinder mount between the first side and the third side.

15. The viewfinder mount of claim 11, further comprising:
a format conversion circuit configured to convert the first image signal to the second image signal.

16. A wearable camera viewfinder apparatus comprising:
an wearable frame configured to be worn by a user; and
at least one electronic viewfinder (EVF) assembly rotatably connected with the wearable frame such that the at least one EVF assembly corresponds to an eye of the user,
wherein the at least one EVF assembly comprises a camera interface configured to receive an image signal from a camera using at least one of a connection cable or a wireless connection between the EVF assembly and the camera.

17. The wearable camera viewfinder apparatus of claim 16, wherein the wearable frame comprises:
an eye frame;
a right arm pivotably connected with a first end of the eye frame; and
a left arm pivotably connected with a second end of the eye frame,
wherein the at least one EVF assembly is pivotably connected to the eye frame.

18. The wearable camera viewfinder apparatus of claim 17, wherein at least one of the right arm or the left arm comprises:
a first portion having a first end and a second end, the first end pivotably connected with the eye frame; and
a second portion slidably connected with the second end of the first portion, the second portion comprising a bent portion shaped for engaging an ear of the user.

19. The wearable camera viewfinder apparatus of claim 17, wherein the at least one EVF assembly comprises:
an electronic viewfinder (EVF) comprising a signal interface; and
a viewfinder mount comprising an EVF interface configured to communicatively and removably connect with the signal interface of the EVF for transferring the image signal.

20. The wearable camera viewfinder apparatus of claim 19, wherein the viewfinder mount further comprising a camera interface for receiving the image signal from the camera via a connection cable removably connected between the camera interface and the camera.

21. The wearable camera viewfinder apparatus of claim 19, wherein the EVF comprises an eyecup for covering an eye of the user.

22. The wearable camera viewfinder apparatus of claim 17,
wherein the at least one EVF assembly comprises a first EVF assembly corresponding to a right eye of the user and a second EVF assembly corresponding to a left eye of the user, and
wherein the first EVF assembly and the second EVF assembly are independently pivotable with respect to the eye frame.

23. The wearable camera viewfinder apparatus of claim 22, wherein the at least one EVF assembly comprises at least one button operable to control an operating mode of the first EVF assembly and the second EVF assembly, the operating mode comprising a binocular mode, monocular mode, and a multi-camera mode.

24. The wearable camera viewfinder apparatus of claim 16, further comprising a camera adapter comprising:
a first signal interface configured to removably connect to the camera to receive the image signal; and
a second signal interface configured to transmit the image signal to the at least one EVF assembly.
